(19) United States
(12) Patent Application Publication
(10) Pub. No.: US 2026/0298616 A1
(43) Pub. Date: Oct. 1, 2026

(54) SHAPE MEASUREMENT SYSTEM, PROCESSING APPARATUS, SHAPE MEASUREMENT METHOD, PROCESSING METHOD, AND CHIP MANUFACTURING METHOD

(71) Applicant: DISCO CORPORATION, Tokyo (JP)

(72) Inventor: Shuichiro TSUKIJI, Tokyo (JP)

(21) Appl. No.: 19/542,100

(22) Filed: Feb. 17, 2026

(30) Foreign Application Priority Data
Mar. 31, 2025 (JP) 2025-058047

(51) Int. Cl. G01B 9/0209; G01B 11/24

(52) U.S. Cl. CPC G01B 9/0209; G01B 11/2441

(57) ABSTRACT

A shape measurement system includes a holding unit, a measurement optical system which is disposed apart from the holding unit in a first direction, a moving unit which moves the measurement optical system and the holding unit relative to each other, and a controller. The measurement optical system includes a light source which emits low-coherence light, a splitting section which splits the light into reference light which is applied to a reference surface and measurement light which is applied to the object, an objective lens which focuses the measurement light onto the object, and a photoelectric conversion device which has a plurality of photoelectric conversion elements which receive interference light resulting from interference between the reference light and the measurement light. When the object is scanned with the measurement light, an optical axis of the objective lens is inclined to the second direction.

### BACKGROUND OF THE INVENTION

### Field of the Invention

The present invention relates to a shape measurement system which measures a three-dimensional shape of an object, a processing apparatus which processes a workpiece, a shape measurement method of measuring the three-dimensional shape of the object, a processing method of processing the workpiece, and a chip manufacturing method of manufacturing chips from the workpiece.

### Description of the Related Art

In a wafer having an insulating film (that is, a Low-k film) including a Low-k material (that is, a material having a lower dielectric constant than silicon dioxide) provided on a front surface thereof, the wafer may be divided into a plurality of chips along a plurality of dividing lines set on the front surface of the wafer, in some cases. In the case of dividing the wafer, there is proposed a method of, first, applying a laser beam to the wafer along each of the dividing lines, then performing ablation processing on the wafer to form a narrow processing groove (that is, a groove) where the Low-k film is removed, and causing a cutting blade to cut in the processing groove, thereby dividing the wafer into a plurality of chips (see, for example, Japanese Patent Laid-Open No. 2005-64231). A laser processing apparatus which removes a Low-k film to form grooves may have a white light interferometer in order to determine a processing quality of ablation processing by measuring a three-dimensional shape of a processing groove (see, for example, Japanese Patent Laid-Open No. 2015-85397).

When a three-dimensional shape of a processing groove formed in one surface (that is, a measurement surface) of a workpiece such as a wafer is to be measured with a white light interferometer, while the white light interferometer is moved along a thickness direction (that is, a height direction) of the workpiece, interference light is applied at each of height positions of the workpiece to capture an image of a predetermined range. After the three-dimensional shape of the processing groove in the predetermined range of the measurement surface is measured in this manner, the workpiece and the white light interferometer are slightly translated in parallel along the measurement surface. Then, similarly, while the white light interferometer is moved along the height direction, an image of the predetermined range of the measurement surface is captured with the interference light at each of the height positions, so that the three-dimensional shape of the processing groove in the predetermined range (that is, in an imaged region) of the measurement surface is measured. In this manner, by repeating operations including movement of the white light interferometer along the height direction of the workpiece and parallel translation of the workpiece and the white light interferometer along the measurement surface, the entire region of the processing groove is imaged, so that the three-dimensional shape of the entire region of the processing groove can be measured.

However, since the predetermined range of the measurement surface is imaged at each height position, a moving speed of the white light interferometer along the height direction is limited by a frame rate (that is, the number of still images that can be imaged by an imaging element per unit of time) of the imaging element in the white light interferometer. Hence, simply increasing the moving speed in the height direction is difficult. Meanwhile, a large number of processing grooves may be formed in one workpiece, and measurement of a plurality of workpieces each having the large number of processing grooves may be required one after another. Hence, measurement of the three-dimensional shape of an object using interference light needs to be made more efficiently.

### SUMMARY OF THE INVENTION

Accordingly, an aim of the present invention is to shorten measurement time when the three-dimensional shape of the object is measured using the interference light.

In accordance with an aspect of the present invention, there is provided a shape measurement system of measuring a three-dimensional shape of an object, including a holding unit which holds the object, a measurement optical system which is disposed apart from the holding unit in a first direction, a moving unit which moves the measurement optical system and the holding unit relative to each other along a second direction crossing the first direction, and a controller which controls the moving unit. The measurement optical system includes a light source which emits low-coherence light, a splitting section which splits the light from the light source into reference light which is applied to a reference surface serving as a reflecting surface and measurement light which is applied to the object, an objective lens which focuses the measurement light onto the object, and a photoelectric conversion device which has a plurality of photoelectric conversion elements which receive interference light resulting from interference between the reference light reflected by the reference surface and the measurement light reflected by the object. When the moving unit moves the measurement optical system and the holding unit relative to each other along the second direction to scan the object with the measurement light, an optical axis of the objective lens is inclined to the second direction at a predetermined angle.

Preferably, the controller controls the moving unit to cause the photoelectric conversion device to image the object while changing a relative position between the measurement optical system and the object, thereby causing the plurality of photoelectric conversion elements to receive the interference light between the measurement light reflected by a measurement surface of the object and the reference light at each of relative positions, and calculating the three-dimensional shape of the object according to information regarding each of the relative positions and an amount of light received by each of the photoelectric conversion elements at each of the relative positions.

In accordance with another aspect of the present invention, there is provided a processing apparatus which processes a workpiece, including a holding unit which holds the workpiece, a processing unit which processes the workpiece, a measurement optical system which is disposed apart from the holding unit in a first direction, a moving unit which moves the measurement optical system and the holding unit relative to each other along a second direction crossing the first direction, and a controller which controls the moving unit. The measurement optical system has a light source which emits low-coherence light, a splitting section which splits the light from the light source into reference light which is applied to a reference surface serving as a reflecting surface and measurement light which is applied to the workpiece, an objective lens which focuses the measurement light onto the workpiece, and a photoelectric conversion device which has a plurality of photoelectric conversion elements which receive interference light resulting from interference between the reference light reflected by the reference surface and the measurement light reflected by the workpiece. When the moving unit causes the measurement optical system and the holding unit to move relative to each other along the second direction to scan the workpiece with the measurement light, an optical axis of the objective lens is inclined to the second direction at a predetermined angle.

In accordance with a further aspect of the present invention, there is provided a shape measurement method of measuring a three-dimensional shape of an object, including applying, of low-coherence light which is split into reference light which is applied to a reference surface and measurement light which is applied to the object, the measurement light through an objective lens to the object held by a holding unit, receiving interference light resulting from interference between the reference light reflected by the reference surface and the measurement light reflected by the object by a photoelectric conversion device, and changing a relative position between the photoelectric conversion device and the object held by the holding unit which are disposed apart from each other in a first direction, along a second direction crossing the first direction. The three-dimensional shape of the object is measured by the receiving the interference light by the photoelectric conversion device and the changing the relative position between the photoelectric conversion device and the object in the second direction. In the changing the relative position between the photoelectric conversion device and the object along the second direction, in a state in which an optical axis of the objective lens is inclined to the second direction at a predetermined angle, the photoelectric conversion device and the objective lens are moved relative to the holding unit along the second direction to scan the object with the measurement light.

In accordance with a still further aspect of the present invention, there is provided a processing method of processing a workpiece, including processing the workpiece by a processing unit to form a processing mark, after formation of the processing mark, applying, of low-coherence light which is split into reference light which is applied to a reference surface and measurement light which is applied to the processing mark, the measurement light to the processing mark of the workpiece held by a holding unit through an objective lens, and receiving interference light resulting from interference between the reference light reflected by the reference surface and the measurement light reflected by the processing mark by a photoelectric conversion device, and after formation of the processing mark, changing a relative position between the photoelectric conversion device and the processing mark of the workpiece held by the holding unit which are disposed apart from each other in a first direction, along a second direction crossing the first direction. A three-dimensional shape of the processing mark is measured by the receiving the interference light by the photoelectric conversion device and the changing the relative position between the photoelectric conversion device and the processing mark along the second direction. In the changing the relative position between the photoelectric conversion device and the processing mark along the second direction, in a state in which an optical axis of the objective lens is inclined to the second direction at a predetermined angle, the photoelectric conversion device and the objective lens are moved relative to the holding unit along the second direction to scan the processing mark with the measurement light.

In accordance with a still further aspect of the present invention, there is provided a chip manufacturing method of manufacturing chips from a workpiece, including processing the workpiece by a processing unit to form a processing groove portion having such a depth as not to fully cut the workpiece, after formation of the processing groove portion, measuring a three-dimensional shape of the processing groove portion, and after measurement of the three-dimensional shape of the processing groove portion, cutting the workpiece so as to pass through a bottom portion of the processing groove portion, to divide the workpiece into chips. The measuring the three-dimensional shape of the processing groove portion includes applying, of low-coherence light which is split into reference light which is applied to a reference surface and measurement light which is applied to the processing groove portion, the measurement light to the processing groove portion of the workpiece held by a holding unit through an objective lens, receiving interference light resulting from interference between the reference light reflected by the reference surface and the measurement light reflected by the processing groove portion by a photoelectric conversion device, and changing a relative position between the photoelectric conversion device and the processing groove portion of the workpiece held by the holding unit which are disposed apart from each other in a first direction, along a second direction crossing the first direction. In the changing the relative position between the photoelectric conversion device and the processing groove portion of the workpiece held by the holding unit along the second direction, in a state in which an optical axis of the objective lens is inclined to the second direction at a predetermined angle, the photoelectric conversion device and the objective lens are moved relative to the holding unit along the second direction to scan the processing groove portion with the measurement light.

In accordance with a still further aspect of the present invention, there is provided a chip manufacturing method of manufacturing chips from a workpiece, including processing the workpiece by a processing unit and forming a processing groove portion which fully cuts the workpiece to divide the workpiece into chips, and after formation of the processing groove portion, measuring a three-dimensional shape of the processing groove portion. The measuring the three-dimensional shape of the processing groove portion includes applying, of low-coherence light which is split into reference light which is applied to a reference surface and measurement light which is applied to the processing groove portion, the measurement light to the processing groove portion of the workpiece held by a holding unit through an objective lens, receiving interference light resulting from interference between the reference light reflected by the reference surface and the measurement light reflected by the processing groove portion by a photoelectric conversion device, and changing a relative position between the photoelectric conversion device and the processing groove portion of the workpiece held by the holding unit which are disposed apart from each other in a first direction, along a second direction crossing the first direction. In the changing the relative position between the photoelectric conversion device and the processing groove portion of the workpiece held by the holding unit along the second direction, in a state in which an optical axis of the objective lens is inclined to the second direction at a predetermined angle, the photoelectric conversion device and the objective lens are moved relative to the holding unit along the second direction to scan the processing groove portion with the measurement light.

The shape measurement system according to one mode of the present invention includes a holding unit which holds the object, a measurement optical system which is disposed apart from the holding unit in a first direction, and a moving unit which moves the measurement optical system and the holding unit relative to each other along a second direction crossing the first direction. The measurement optical system includes a light source which emits low-coherence light, a splitting section which splits the light from the light source into reference light and measurement light, an objective lens which focuses the measurement light onto the object, and a photoelectric conversion device which has a plurality of photoelectric conversion elements which receive interference light.

Then, when the moving unit moves the measurement optical system and the holding unit relative to each other along the second direction to scan the object with the measurement light, the optical axis of the objective lens of the measurement optical system is inclined to the second direction (for example, the X axis direction) at a predetermined angle. In this manner, in a state in which the optical axis of the objective lens is inclined to the second direction at the predetermined angle, by moving the measurement optical system and the holding unit relative to each other along the second direction, height information regarding the object in a region which is scanned with the measurement light can be acquired.

In contrast, in the related technique, in order to acquire the height information regarding the object in a stripe-like region along the second direction, first, with the optical axis of the objective lens being parallel to the first direction (for example, the Z axis direction) perpendicular to the second direction, the measurement optical system and the holding unit are moved relative to each other along the first direction (i.e., vertical scanning is performed), so that the height information regarding the object in one region where the measurement light is applied in a spot-like manner is acquired. Subsequently, by shifting the measurement optical system and the holding unit relative to each other in the second direction by a predetermined distance, the measurement light is moved to another region adjacent to the relevant one region in the second direction. Then, in a state in which the measurement light is applied in a spot-like manner, by moving the measurement optical system and the holding unit relative to each other again along the first direction, the height information regarding the object in the relevant another region is acquired. In this manner, by repeating operations including moving the measurement optical system and the holding unit relative to each other in the first direction and shifting the measurement optical system and the holding unit relative to each other in the second direction by the predetermined distance (i.e., by vertical scanning low-coherence interferometry), the height information regarding the object in the strip-like region along the second direction is acquired.

In contrast, in a state in which the optical axis of the objective lens is inclined to the second direction at a predetermined angle, by moving the measurement optical system and the holding unit relative to each other along the second direction, the height information regarding the object in a region which is scanned with the measurement light can be acquired, resulting in achieving significant simplification of the repetitive operation described above. Hence, the measurement time for measuring the three-dimensional shape can be reduced. The processing apparatus according to another mode of the present invention also includes the shape measurement system described above. Hence, the measurement time for measuring the three-dimensional shape can be reduced. In the shape measurement method, the processing method, and the chip manufacturing method according to still further modes of the present invention, similarly, the measurement time for measuring the three-dimensional shape can be reduced.

The above and other objects, features and advantages of the present invention and the manner of realizing them will become more apparent, and the invention itself will best be understood from a study of the following description and appended claims with reference to the attached drawings showing preferred embodiments of the invention.

### BRIEF DESCRIPTION OF THE DRAWINGS

FIG. 1 is a schematic diagram of a processing apparatus;

FIG. 2 is a schematic diagram of a shape measurement system;

FIG. 3 is a result of simulation indicating interference of low-coherence light;

FIG. 4A is a diagram depicting the manner in which a pixel P₀ receives measurement light that is reflected at a point A at time t₁;

FIG. 4B is a diagram depicting the manner in which a pixel P_{N} receives measurement light that is reflected at the point A at time t₂;

FIG. 5A is a graph indicating temporal change in optical path length when the measurement light reflected at the point A is received by any one of pixels P;

FIG. 5B is a graph indicating an optical path difference ΔL(t) which is adjusted to be zero at a pixel P_{M};

FIG. 6A is a diagram depicting imaging at time t_{A} at which the optical axis passes through the point A;

FIG. 6B is a diagram depicting imaging at time t_{B};

FIG. 6C is a diagram depicting imaging at time t_{C};

FIG. 7 is a flowchart indicating a processing method for a workpiece;

FIG. 8 is a perspective view of the workpiece;

FIG. 9A is a diagram depicting the manner in which ablation processing is performed on the workpiece;

FIG. 9B is a cross-sectional view of the workpiece including processing marks;

FIG. 10A is a diagram depicting the manner in which imaging of one processing mark is started;

FIG. 10B is a diagram depicting the manner in which imaging of the one processing mark is ended;

FIG. 11 is a flowchart indicating one example of a device chip manufacturing method;

FIG. 12A is a diagram depicting a modified region forming step;

FIG. 12B is a diagram depicting a back surface grinding step;

FIG. 12C is a perspective view of a device chip;

FIG. 13 is a flowchart indicating a modification example of the device chip manufacturing method; and

FIG. 14 is a cross-sectional view of the workpiece having been subjected to cutting by ablation processing.

### DETAILED DESCRIPTION OF THE PREFERRED EMBODIMENTS

### First Embodiment

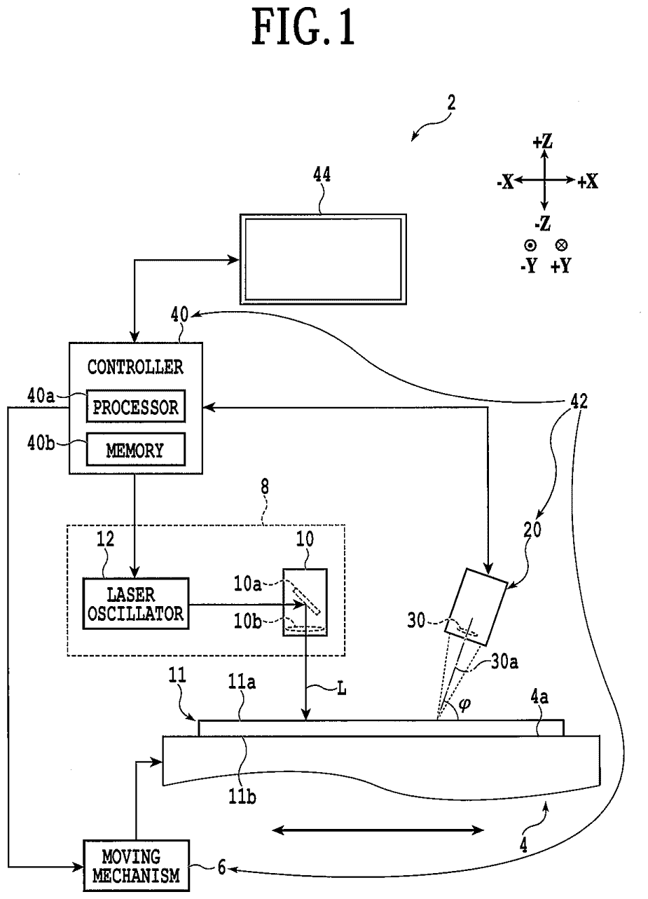

With reference to the attached drawings, a preferred embodiment according to one mode of the present invention will be described. FIG. 1 is a schematic diagram of a processing apparatus 2 which processes a workpiece (that is, an object) 11. FIG. 1 depicts some of components of the processing apparatus 2 by functional blocks in a simplified manner. An X axis, a Y axis, and a Z axis depicted in FIG. 1 are perpendicular to each other (that is, orthogonal to each other). In FIG. 1, a positive direction of the X axis is set to a +X direction, and a negative direction of the X axis is set to a −X direction. The +X direction and the −X direction extend in opposite directions. In the present specification, the +X direction and the −X direction may collectively be referred to as an X axis direction (or as a second direction or a processing feed direction). In FIG. 1, a positive direction of the Y axis is set as a +Y direction, and a negative direction of the Y axis is set to a −Y direction. The +Y direction and the −Y direction extend in opposite directions. In the present specification, the +Y direction and the −Y direction may collectively be referred to as a Y axis direction (or as an index feed direction). Further, in FIG. 1, a positive direction of the Z axis is set to a +Z direction, and a negative direction of the Z axis is set to a −Z direction. The +Z direction and the −Z direction extend in opposite directions. For example, the −Z direction is a vertical direction (that is, the direction of gravity). In this case, the −Z direction is a downward direction, and the +Z direction is an upward direction. Note that, in the present specification, the +Z direction and the −Z direction may collectively be referred to as the Z axis direction (or as a first direction or a height direction).

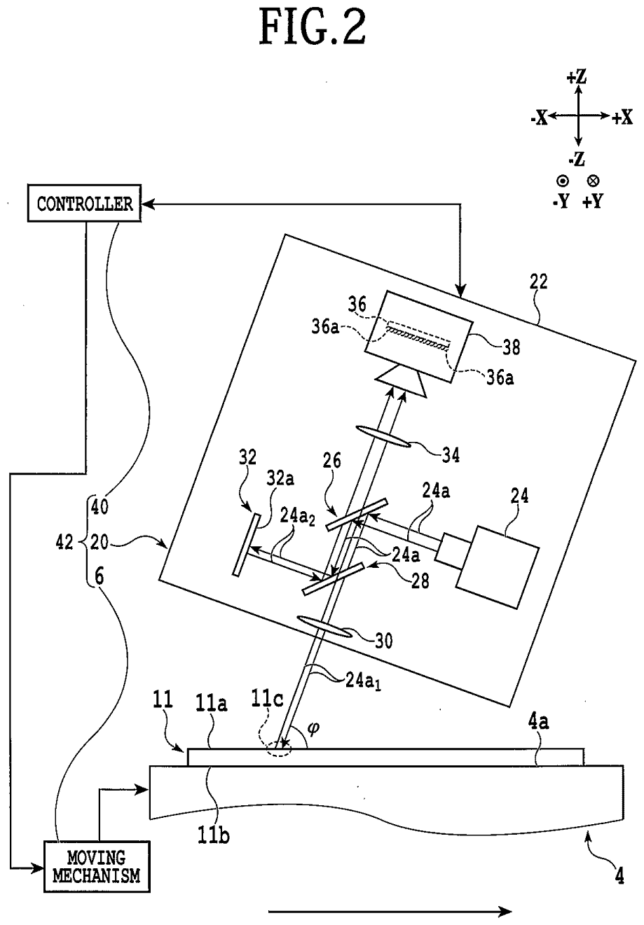

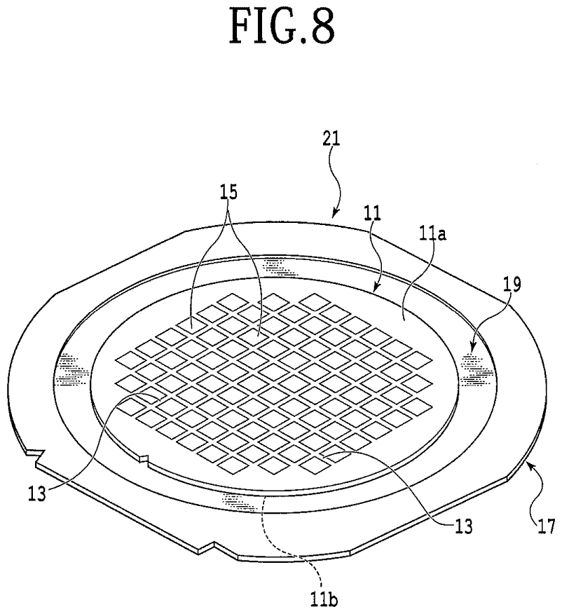

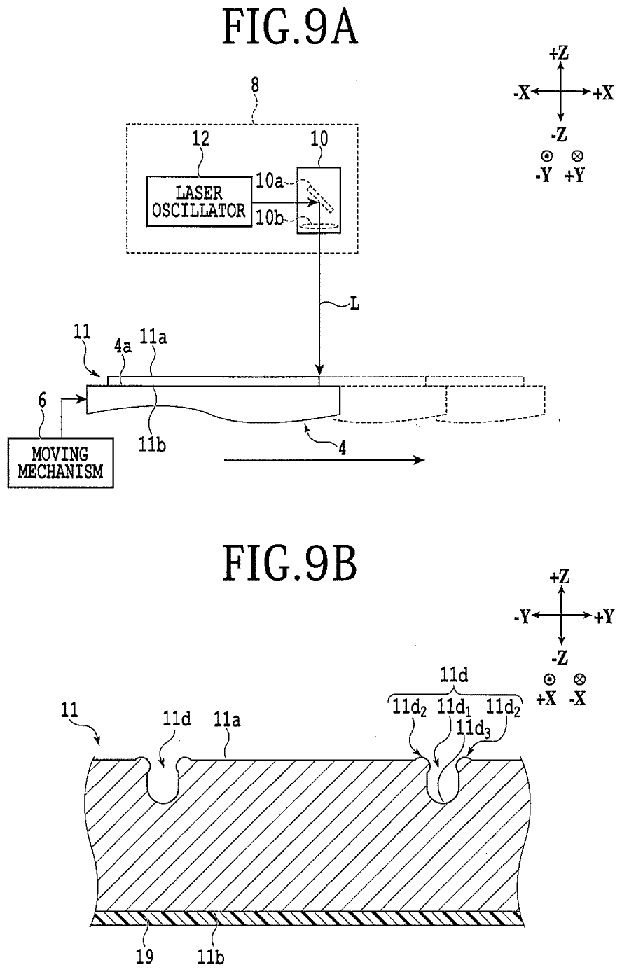

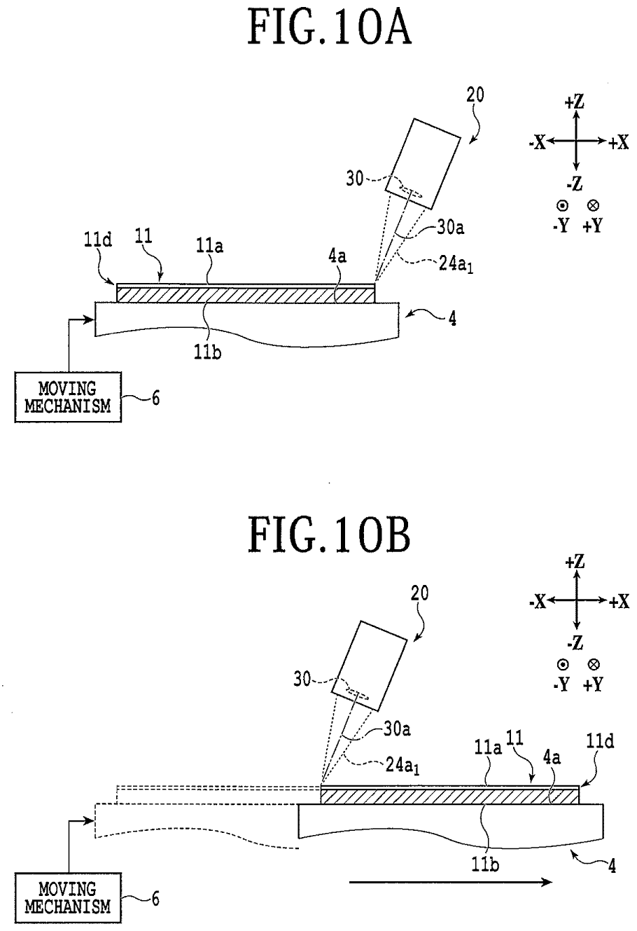

The processing apparatus 2 includes a disc-like chuck table (holding unit) 4 that holds the workpiece 11 under suction by a negative pressure. The chuck table 4 has a disc-like frame body formed of metal such as stainless steel. A radially center portion of the frame body has a disc-like recess provided therein, the recess having a diameter smaller than an outer diameter of the frame body. The recess of the frame body has an undepicted disc-like porous plate formed of porous ceramic disposed therein, and the porous plate is fixed to the frame body with use of an adhesive or the like. Upper surfaces of the frame body and the porous plate are substantially flush with each other and exposed upward. The frame body is connected to an undepicted suction source such as an ejector or a vacuum pump, and a negative pressure from the suction source is transmitted to the upper surface of the porous plate through the frame body. The upper surface of the frame body and the upper surface of the porous plate constitute a holding surface 4a that holds under suction the workpiece 11. Note that, the workpiece 11 is held under suction by the holding surface 4a, and for example, as depicted in FIG. 8, in a form of a workpiece unit 21 in which the workpiece 11 is integrated with a frame 17 through a dicing tape 19. However, in FIG. 1 (FIG. 2, and FIG. 9A through FIG. 10B as well), as a matter of convenience, illustration of the dicing tape 19 and the frame 17 is omitted.

Meanwhile, in place of the chuck table 4, an electrostatic chuck that holds under suction the workpiece 11 by electrostatic attraction may be adopted. In addition, in place of a negative pressure or an electrostatic force or along with one of them, a holding unit having a pressing mechanism including clamps or the like which can be opened and closed by an actuator may directly or indirectly fix the workpiece 11 to its holding surface. In the present embodiment, the holding surface 4a of the chuck table 4 is exposed upward. However, the chuck table 4 may be turned upside down, and the holding surface 4a thereof may be exposed downward. Likewise, in a case of adopting the electrostatic chuck, the pressing mechanism, or the like, the holding surface of the adopted one may be exposed downward.

The chuck table 4 is supported by a moving mechanism (that is, a moving unit) 6. The moving mechanism 6 has a θ table (not depicted) which rotates the chuck table 4 around a rotational axis disposed along the Z axis direction. Moreover, the moving mechanism 6 has a first moving plate (not depicted) which supports the chuck table 4 and the θ table. The first moving plate is slidably supported by a pair of X axis direction guide rails (not depicted) each longitudinal portion of which is disposed along the X axis direction. A first screw shaft (not depicted) having a longitudinal portion disposed along the X axis is provided between the pair of X axis direction guide rails. A lower surface of the first moving plate has a first nut portion (not depicted) provided thereon. The first nut portion is coupled to the first screw shaft having the longitudinal portion disposed along the X axis direction, through a plurality of balls (not depicted) in a rotatable manner. One end portion of the first screw shaft has a first drive source (not depicted) coupled therewith, such as a servomotor. When the first drive source is actuated, the first moving plate moves along the X axis direction. The first moving plate, the pair of X axis direction guide rails, the first screw shaft, the first nut portion, the first drive source, and the like constitute an X axis direction moving mechanism. The pair of X axis direction guide rails, the first screw shaft, and the like are supported by a second moving plate (not depicted).

The second moving plate is slidably supported by a pair of Y axis direction guide rails (not depicted) each longitudinal portion of which is disposed along the Y axis direction. A second screw shaft (not depicted) having a longitudinal portion disposed along the Y axis is provided between the pair of Y axis direction guide rails. A lower surface of the second moving plate has a second nut portion (not depicted) provided thereon. The second nut portion is coupled to the second screw shaft having the longitudinal portion disposed along the Y axis direction, through a plurality of balls (not depicted) in a rotatable manner. One end portion of the second screw shaft has a second drive source (not depicted) coupled therewith, such as a servomotor. When the second drive source is actuated, the second moving plate moves along the Y axis direction. The second moving plate, the pair of Y axis direction guide rails, the second screw shaft, the second nut portion, the second drive source, and the like constitute a Y axis direction moving mechanism.

Above the chuck table 4, there is disposed a beam condenser 10 constituting a laser beam applying unit (that is, a processing unit) 8. The laser beam applying unit 8 has a laser oscillator 12. The laser oscillator 12 has, for example, a laser medium that is a crystal including neodymium doped yttrium aluminum garnet (Nd: YAG) or the like. When excitation light is applied from a light source such as a flashlamp or a laser diode to the laser medium, the laser oscillator 12 emits a pulsed laser beam with a wavelength having a predetermined length (for example, 1064 nm). The laser beam emitted from the laser oscillator 12 is converted into a wavelength that is absorbed by the workpiece 11 (for example, 355 nm), by a wavelength conversion unit (not depicted) including a nonlinear optical crystal such as an LBO (that is, LiB₃O₅) crystal, and thereafter enters the beam condenser 10. Then, after a mirror 10a disposed in the beam condenser 10 changes a traveling direction of the laser beam, the laser beam passes through a focusing lens 10b disposed in the beam condenser 10, and is applied substantially vertically toward the holding surface 4a (that is, along the Z axis direction).

In a state in which a focal point of the pulsed laser beam L is positioned in the vicinity of the front surface 11a of the workpiece 11 held under suction on the holding surface 4a, the focal point and the chuck table 4 are moved relative to each other by the moving mechanism 6 along the X axis direction, so that ablation processing can be performed on the workpiece 11 (that is, the workpiece 11 can be processed).

Note that the laser beam L emitted from the laser oscillator 12 may pass through an optical modulator such as an acousto-optic modulator (AOM), an electro-optic modulator (EOM), or a liquid crystal on silicon-spatial light modulator (LCOS-SLM) and may be applied from the beam condenser 10 toward the holding surface 4a. The optical modulator has various functions. For example, the optical modulator adjusts the power of the laser beam L (that is, the average power, the peak of the power, and the like). The optical modulator may control whether or not the laser beam L is applied to the beam condenser 10. The position of the beam condenser 10 in the processing apparatus 2 is substantially fixed, and the focusing lens 10b is configured in such a manner as to be adjustable along the Z axis direction by a piezoelectric actuator. Hence, the position of the focal point of the laser beam L can be adjusted along the Z axis direction.

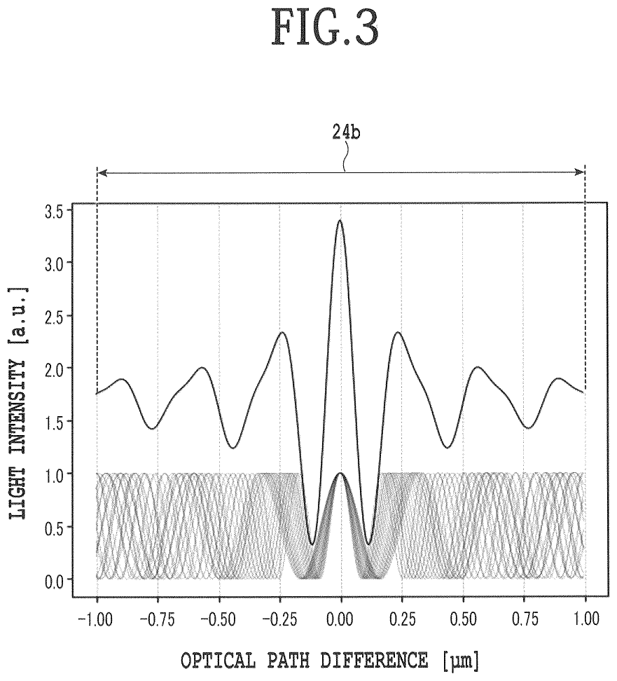

In the vicinity of the beam condenser 10, a measurement optical system 20 is provided. The measurement optical system 20 is disposed apart from the chuck table 4 in the Z axis direction. Here, with reference to FIG. 2, description regarding the measurement optical system 20 will be given. FIG. 2 is a schematic diagram depicting a shape measurement system 42 including the measurement optical system 20. The measurement optical system 20 has a housing 22, and in the housing 22, a white light source (that is, a light source) 24 is fixed. The white light source 24 has a light source such as a superluminescent diode (SLD) or a light emitting diode (LED). The white light source 24 emits light having a continuous spectrum over a relatively broad wavelength band. The white light source 24 in the present example emits white light having the center wavelength of 465 nm, and the white light does not need to be perfectly white in a rigorous sense. The white light source 24 of the present embodiment emits low-coherence light 24a. The low-coherence light 24a has a short coherence length 24b (see FIG. 3). In the present specification, the low-coherence light 24a refers to light having a coherence length 24b of more than 0 μm and equal to or less than 36 μm (more preferably, more than 0 μm and equal to or less than 10 μm), that is generally called, white light.

A first beam splitter 26 is provided at a position apart by a predetermined distance from the white light source 24 in the −X direction. In addition, below the first beam splitter 26, a second beam splitter 28 is provided. Further, below the second beam splitter (that is, a splitting section) 28, an objective lens 30 is provided. The first beam splitter 26 and the second beam splitter 28 in the present example are half mirrors. In the vicinity of the second beam splitter 28, there is provided a mirror 32 on which light reflected by the second beam splitter 28 is incident. The mirror 32 has a reference surface 32a that is a reflecting surface.

Part of the low-coherence light 24a emitted from the white light source 24 successively passes through the second beam splitter 28 and the objective lens 30, and becomes a measurement light 24a₁ which is to be applied to the front surface 11a of the workpiece 11. The objective lens 30 has a function of focusing the measurement light 24a₁ onto the front surface 11a of the workpiece 11. An optical axis 30a of the objective lens 30 in the present embodiment is inclined by a predetermined angle φ to the X axis direction in the XZ plane.

The predetermined angle φ corresponds to an acute angle formed by the optical axis 30a and the X axis direction and is, for example, more than 0 degrees and less than 90 degrees. However, as the angle φ approaches 90 degrees, a measurable range of the measurement optical system 20 in the Z axis direction becomes narrower. In contrast, as the angle φ approaches 0 degrees, the objective lens 30 is required to be separated from the workpiece 11 such that the objective lens 30 and the housing 22 do not come in contact with the workpiece 11, and accordingly, a distance from the objective lens 30 to the workpiece 11 (that is, a working distance (WD)) increases. However, when the WD increases in this manner, the numerical aperture (that is, NA) decreases, so that the resolution of the measurement optical system 20 lowers. In other words, the angle φ is appropriately determined in consideration of a trade-off between the measurable range in the Z axis direction and the resolution. The preferable range of the angle φ is, for example, 75 degrees or more and equal to or less than 89 degrees, more preferably, 78 degrees or more and equal to or less than 88 degrees, and still more preferably, 80 degrees or more and equal to or less than 86 degrees. The most preferred example of the angle φ is 85 degrees.

After the measurement light 24a₁ passing through the objective lens 30 is applied to the front surface 11a, it is reflected by the front surface 11a, successively passes through the second beam splitter 28 and the first beam splitter 26, and travels toward an imaging lens 34 provided above the first beam splitter 26. Meanwhile, other part of the low-coherence light 24a emitted from the white light source 24 is successively reflected by the first beam splitter 26 and the second beam splitter 28, becoming reference light 24a₂ which is applied to and reflected by the reference surface 32a. In this manner, the second beam splitter 28 has a function of splitting the low-coherence light 24a into the measurement light 24a₁ and the reference light 24a₂. The reference light 24a₂ reflected by the reference surface 32a passes through the second beam splitter 28 and the first beam splitter 26 successively, and travels toward the imaging lens 34 as well. Above the imaging lens 34, a camera (that is, a photoelectric conversion device) 38 including a solid-state imaging element 36 is provided. The camera 38 receives interference light resulting from interference between the measurement light 24a₁ and the reference light 24a₂.

Note that the measurement optical system 20 of the present embodiment is generally called the Michelson type, and may be the Mirau type. In the case of the Mirau type, the mirror 32 having the reference surface 32a is disposed between the objective lens 30 and the holding surface 4a on the optical axis of the objective lens 30.

The camera 38 has a typical solid-state imaging element 36 such as a complementary metal-oxide-semiconductor (CMOS) image sensor. An imaging surface of the solid-state imaging element 36 has a plurality of photoelectric conversion elements 36a which can receive the interference light and are disposed in a regular manner (for example, in a grid-like manner). Each of the photoelectric conversion elements 36a includes, for example, a photodiode and a current-voltage conversion circuit and generates a voltage signal corresponding to light intensity of received light. The voltage signal generated in each of the photoelectric conversion elements 36a is eventually output to the controller 40 described below as light intensity information.

As depicted in FIG. 2, the moving mechanism 6, the measurement optical system 20, and the controller 40 constitute the shape measurement system 42 which measures the three-dimensional shape of the workpiece 11. When the front surface (that is, the measurement surface) 11a of the workpiece 11 held on the holding surface 4a is imaged, the moving mechanism 6 moves the measurement optical system 20 and the workpiece 11 along the X axis direction relative to each other. Upon scanning the front surface 11a of the workpiece 11 with the measurement light 24a₁ by such a relative movement, the optical axis 30a is inclined by the predetermined angle φ to the X axis direction, so that the three-dimensional shape of the front surface 11a (that is, a measurement region 11c) can be measured along a trajectory of the measurement light 24a₁ (that is, a long and thin strip-shaped region). By inclining the optical axis 30a to the X axis direction, (i.e., by inclining the optical axis 30a to the Z axis direction), measurement of the three-dimensional shape of the front surface 11a can be achieved simply by moving the measurement optical system 20 relative to the holding surface 4a in the X axis direction in a state in which the position in the Z axis direction of the measurement optical system 20 (that is, the objective lens 30) is fixed, which is one of the features of the present embodiment.

FIG. 3 is a result of simulation indicating interference of the low-coherence light 24a. An axis of abscissas in FIG. 3 represents an optical path difference (μm) between the measurement light 24a₁ and the reference light 24a₂ from the camera 38 to the measurement region 11c, and an axis of ordinate in FIG. 3 represents light intensity (a.u.) of the interference light received by the camera 38. When the optical path difference is 0 (μm), the measurement light 24a₁ and the reference light 24a₂ constructively interfere with each other, and the light intensity of the interference light reaches a peak value. In addition, intensity variation of the interference light occurs in the imaging surface of the solid-state imaging element 36 also in a case in which the optical path difference is other than 0 (μm), although the intensity variation of the interference light in this case is weaker than that in the case in which the optical path difference is 0 (μm).

Note that, in the example of FIG. 3, when the optical path difference is outside the range of ±1 μm (that is, the coherence length 24b), the measurement light 24a₁ and the reference light 24a₂ destructively interfere with each other, and intensity variation of the interference light does not occur in the imaging surface of the solid-state imaging element 36 in practice. The low-coherence light 24a in the present example is generally called white light having a center wavelength of 465 nm, and only in a range in which the optical path difference is 1.395 μm corresponding to one way of 2.79 μm (=465 nm×six wavelengths), interference between the measurement light 24a₁ and the reference light 24a₂ occurs.

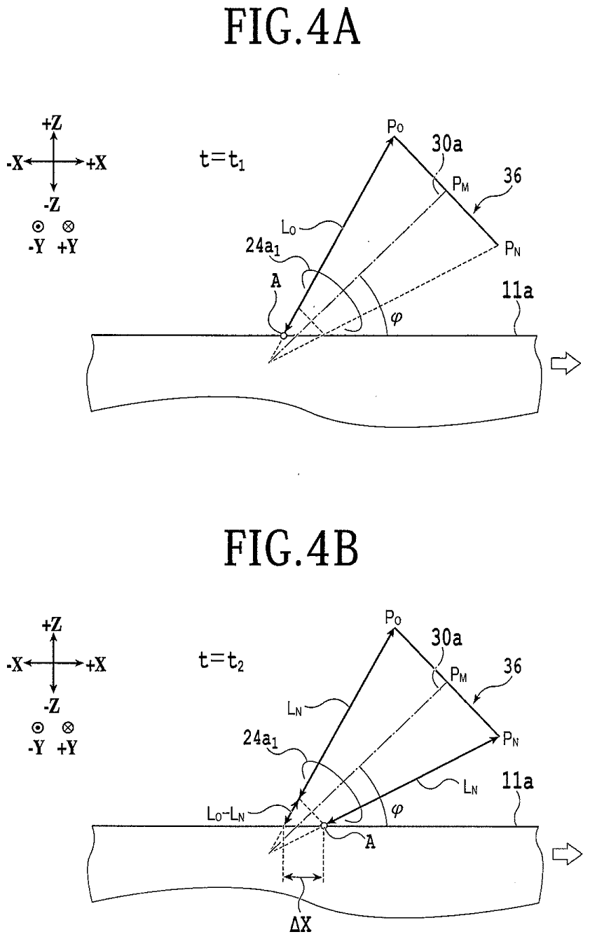

Next, with reference to FIG. 4A to FIG. 6C, a scheme in which the measurement optical system 20 measures the three-dimensional shape of the front surface 11a will be described. Note that, as a matter of convenience, the plurality of photoelectric conversion elements 36a which are disposed in one dimension on a particular XZ plane where the optical axis 30a is present will be described, but the similar description regarding the plurality of photoelectric conversion elements 36a which are arrayed in a grid-like manner on a two-dimensional plane perpendicular to the optical axis 30a is also established. In addition, regarding description of FIG. 4A to FIG. 6C, as a matter of convenience, one photoelectric conversion element 36a is referred to as a pixel, while being represented as the character P, and characters from 0 to N are denoted at the lower right of each pixel P along one-dimensional array direction (N is typically a natural number from substantially 1000 to 2000). Note that a pixel P_{M} is a pixel P, among a plurality of pixels P which are arrayed in one dimension, which is positioned at a center of a line segment connecting a pixel P₀ being positioned at one end thereof to a pixel P_{N} being positioned at the other end thereof opposite to the one end and which intersects the optical axis 30a.

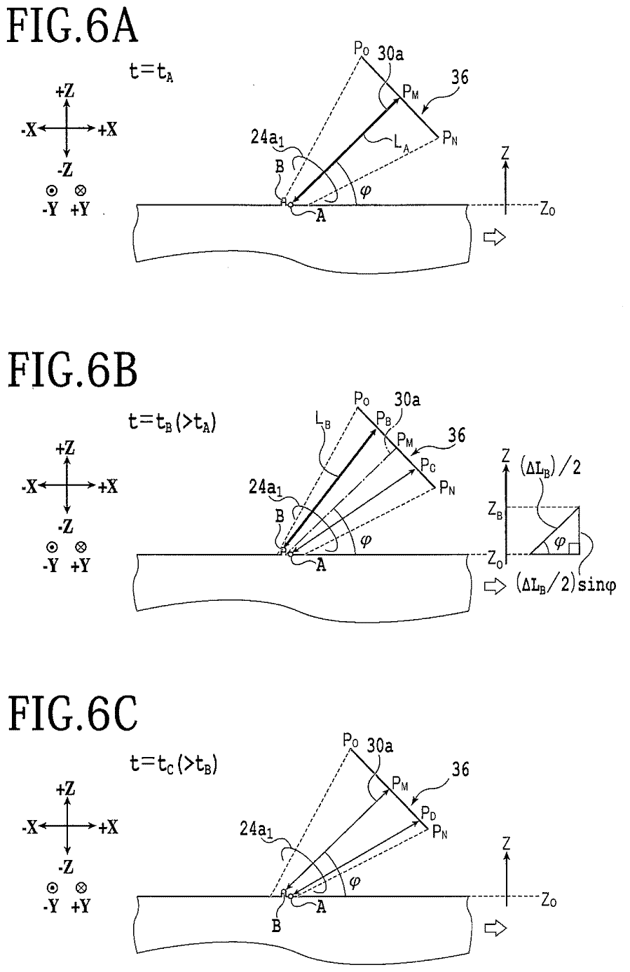

FIG. 4A is a diagram depicting the manner in which the pixel P₀ receives the measurement light 24a₁ that is reflected at a point A of the front surface 11a at time t₁. Note that, although each pixel P receives the reference light 24a₂ at the same time, as a convenience of description, in FIG. 4A, illustration of the reference light 24a₂ is omitted. In addition, in FIG. 4A, FIG. 4B, and FIG. 6A to FIG. 6C, as a matter of convenience, illustration of the objective lens 30 is omitted. This objective lens 30 is a telecentric lens, and the measurement light 24a₁ is emitted substantially parallel to the optical axis of the objective lens 30, through the objective lens 30 to the front surface 11a.

In the present embodiment, at the time of imaging the workpiece 11, imaging is performed while the chuck table 4 is moved to the +X-direction side at a given speed, and accordingly, at time t₂ at which a predetermined time has lapsed from time t₁, the point A has relatively been moved by ΔX to the +X-direction side (see FIG. 4B). FIG. 4B is a diagram depicting the manner in which the pixel P_{N} receives the measurement light 24a₁ that is reflected at the point A of the front surface 11a at time t₂. Note that, also in FIG. 4B, illustration of the reference light 24a₂ is omitted. As depicted in FIG. 4B, owing to the inclination of the optical axis 30a (that is, the predetermined angle φ), the optical path length L₀ when the measurement light 24a₁ reflected at the point A is received by the pixel P₀ at time t₁ is longer than the optical path length L_{N} when the measurement light 24a₁ reflected at the point A is received by the pixel P_{N} at time t₂ (that is, L_{N}<L₀). As seen in FIG. 4A and FIG. 4B, owing to the inclination of the optical axis 30a, the measurement light 24a₁ reflected at the point A and received by the solid-state imaging element 36 has different optical path lengths according to relative positions in the X axis direction between the point A and the measurement optical system 20.

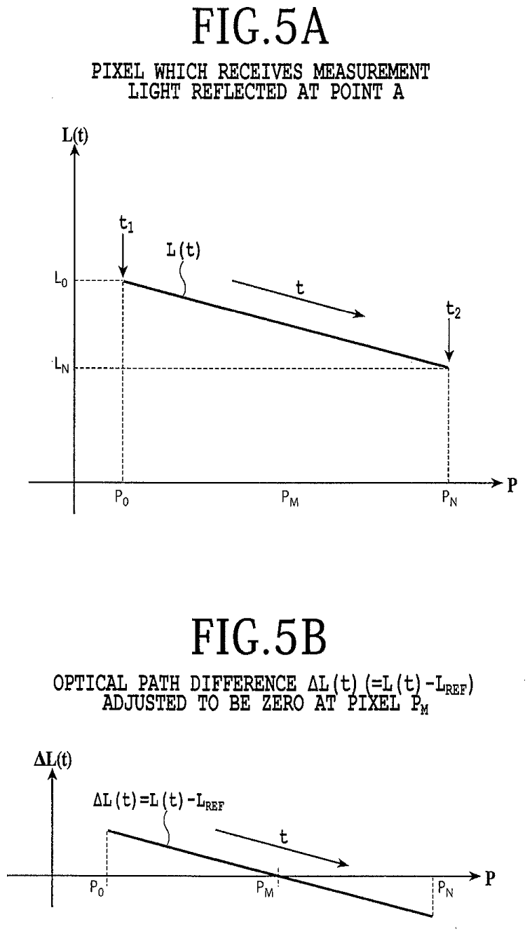

FIG. 5A is a graph indicating temporal change (that is, L(t)) in optical path length when the measurement light 24a₁ reflected at the point A is received by any one of the pixels P, and corresponds to FIG. 4A (t=t₁) to FIG. 4B (t=t₂). In the present embodiment, the point A is imaged with the interference light. The interference light is represented by a difference between the measurement light 24a₁ and the reference light 24a₂, and the optical path difference ΔL(t) obtained by subtracting the optical path length L_{REF} (note that, L_{REF} is always maintained at a constant value) of the reference light 24a₂ from L(t) by the following equation ΔL(t)=L(t) L_{REF} (see FIG. 5B).

Meanwhile, for example, in a state in which the measurement optical system 20 is fixed in position relative to the workpiece 11 in the XY plane, when the measurement optical system 20 is moved along the Z axis direction, the optical path length of the measurement light 24a₁ changes according to the position of the measurement optical system 20 in the Z axis direction. Specifically, the optical path difference ΔL(t) is moved up and down according to the position of the measurement optical system 20 in the Z axis direction. In view of this, in the present embodiment, in such a manner that the optical path difference ΔL(t) reaches zero at the pixel P_{M} at a predetermined timing (that is, in such a manner as to satisfy a condition under which the interference is strongest (for example, a constructive interference condition)), the position of the measurement optical system 20 in the Z axis direction is adjusted (see FIG. 5B). FIG. 5B is a graph indicating the optical path difference ΔL(t) which is adjusted to be zero at the pixel P_{M}. In addition, at the pixel P_{M}, the optical path difference ΔL(t)=0 when the optical axis 30a passes through the point A, and the height position of the point A in the Z axis direction at this time is set to a reference height Z₀. Note that the point A is not always one point on the flat plane and may be any one point on the front surface 11a.

After the reference height Z₀ is set, how the height of the front surface 11a is measured in a case in which irregularities are present in the front surface 11a will be described with reference to FIG. 6A to FIG. 6C. FIG. 6A is a diagram depicting imaging of the front surface 11a of the workpiece 11 at time t_{A} at which the optical axis 30a passes through the point A.

At time t_{A}, the measurement light 24a₁ reflected at the point A is received by the pixel P_{M}. The point A is present at the reference height Z₀ with respect to the measurement optical system 20, and since the optical path difference ΔL(t) reaches zero at the pixel P_{M}, the interference becomes strongest. In FIG. 6A, the strongest interference is depicted with a relatively thick solid line between the point A and the pixel P_{M}. In addition, since the condition under which the interference is strongest (for example, the constructive interference condition) is satisfied at the pixel P_{M}, the length of the optical path length L_{A} between the point A and the pixel P_{M} can be calculated in a rigorous sense.

FIG. 6B is a diagram depicting the manner in which imaging of the front surface 11a is performed at time t_{B} after time t_{A} (that is, t_{B}>t_{A}) while the chuck table 4 and the workpiece 11 are moved to the +X-direction side at a predetermined speed. At time t_{B}, an intersection between the optical axis 30a and the front surface 11a is present between a point B and the point A. Note that the point B is present at a vertex of a protrusion which projects relative to the point A toward the +Z-direction side. Here, it is assumed that the interference between the measurement light 24a₁ reflected at the point B and the reference light 24a₂ becomes strongest at a pixel P_{B} that is positioned between the pixel P₀ and the pixel P_{M}. In FIG. 6B, the strongest interference is depicted with a relatively thick solid line between the pixel P_{B} and the point B.

Next, the height Z_{B} of the point B is evaluated with respect to the reference height Z₀ in terms of the height position. In the present embodiment, with use of ΔL(t) depicted in FIG. 5B, the optical path difference ΔL_{B} obtained when the interference becomes strongest at the pixel P_{B} is converted into the height in the Z axis direction.

Note that, since ΔL(t) in the present embodiment is a function of time t as well as a function of the position of the pixel P, this is represented by ΔL(P), and by designating the pixel P_{B}, ΔL(P_{B}) (that is, optical path difference ΔL_{B}) is determined from the graph of ΔL(t) depicted in FIG. 5B.

More specifically, taking into account that the optical path difference ΔL_{B} includes the double-pass length of the measurement light 24a₁, a right-angled triangle having half of the optical path difference ΔL_{B} (=ΔL_{B}/2) as an oblique side, a base being present at Z=Z₀, one acute angle being in contact with the base with the above-described predetermined angle φ (see the right side of FIG. 6B) will be considered. As seen clearly from this right-angled triangle, the height Z_{B} of the point B is represented by the equation (1). Note that calculation of the equation indicated in (1) and the like is automatically performed by the controller 40.

$$\begin{matrix}[ Math . 1 ] & \\ {Z}_{B} = {Z}_{0} + ( Δ {L}_{B} / 2 ) sin φ & ( 1 )\end{matrix}$$

Note that, in the example depicted in FIG. 5B and FIG. 6B, ΔL(P_{B}) is positive (that is, 0 <ΔL(P_{B})) (that is, Z_{B} is higher than Z₀), but even in a case in which ΔL(P_{B}) is negative (that is, ΔL(P_{B})<0) (that is, Z_{B} is lower than Z₀), the height Z_{B} of the point B can similarly be calculated. More specifically, in FIG. 5B, in a case in which ΔL(P_{B}) is negative, the height Z_{B} of the point B is represented by the equation (2).

$$\begin{matrix}[ Math . 2 ] & \\ {{Z}_{B}}_{\\} = {Z}_{0} - ( \vert Δ {L}_{B} \vert / 2 ) sin φ & ( 2 )\end{matrix}$$

In FIG. 6B, although the measurement light 24a₁ reflected at the point A is received by a pixel P_{C}, the condition under which the interference is strongest (for example, the constructive interference condition) is not satisfied at the pixel P_{C}, and for example, the destructive interference condition is satisfied. This is indicated with a relatively thin solid line between the pixel P_{C} and the point A.

FIG. 6C is a diagram depicting the manner in which imaging of the front surface 11a is performed while the chuck table 4 and the workpiece 11 are sequentially moved to the +X-direction side at a predetermined speed, at time t_{C} (>t_{B}). At time t_{C}, the optical axis 30a passes through the point B. At the pixel P_{M}, the condition under which the interference is strongest is not satisfied, and for example, the destructive interference condition is satisfied. This is indicated with a relatively thin solid line between the pixel P_{M} and the point B.

Also, at time t_{C}, the measurement light 24a₁ reflected at the point A is received by a pixel P_{D}, and at the pixel P_{D}, the condition under which the interference is strongest is not satisfied (for example, the destructive interference condition is satisfied). The state in which the condition under which the interference is strongest is not satisfied is indicated with a relatively thin solid line between the pixel P_{D} and the point A.

To give a slightly more generalized explanation, in the present embodiment, the measurement light 24a₁ reflected at a freely-selected point Q (not depicted) being present on a line segment (virtual line segment Q (not depicted)) passing through the point A and parallel to a line segment connecting the pixel P₀ to the pixel P_{N} satisfies the condition under which the interference is strongest at the pixel P. Then, if the pixel P satisfying the condition under which the interference is strongest is identified, the height of the point Q in the Z axis direction can be identified. The measurement optical system 20 and the chuck table 4 are moved relative to each other along the X axis direction, so that it is possible to identify the pixel P satisfying the condition under which the interference is strongest and the height of the point Q in the Z axis direction in such a manner as to be associated with each other in a one-to-one correspondence along the trajectory of the focal point of the measurement light 24a₁. In this manner, it is possible to identify an irregular shape of the front surface 11a along the trajectory of the focal point of the measurement light 24a₁.

Note that it is also possible for the controller 40 to acquire X coordinates and Y coordinates of the point A, the point B, and the like (that is, the point Q) on the basis of the position of each of the pixels P relative to the pixel P (for example, the pixel P_{M}) serving as a reference, the initial position of each of the measurement optical system 20 and the workpiece 11, the moving speed, an inclination angle of the optical axis 30a, and the like. In a case in which the moving mechanism 6 has a position information detecting mechanism such as a linear encoder, the controller 40 can also acquire the X coordinates and Y coordinates of the point A, the point B, and the like (that is, the point Q) according to position information detected by the position information detecting mechanism.

In the present embodiment, in a state in which the optical axis 30a of the objective lens 30 is inclined to the X axis direction at the predetermined angle φ, the measurement optical system 20 and the chuck table 4 are moved relative to each other along the X axis direction, so that the height information of the object of the workpiece 11 in a region which has been scanned with the measurement light 24a₁ can be acquired. Accordingly, in comparison to the vertical scanning low-coherence interferometry in the related technique, repeating operations including moving the measurement optical system 20 to the Z-axis direction side and shifting the chuck table 4 to the X-axis direction side by a predetermined distance can be significantly simplified, so that the measurement time for measuring the three-dimensional shape can be reduced.

Note that, as a method of determining the time at which the interference is strongest, in data or a graph including a relative position between the measurement optical system 20 and the workpiece 11 (note that, in the present example in which the relative moving speed along the X axis direction is constant, the relative position is also a function of time) and the light intensity, using a rate of change of the light intensity can be considered. For example, in a graph with the relative position as the axis of abscissas and the light intensity as the axis of ordinate, the controller 40 monitors the rate of change of the light intensity (that is, the derivative of the light intensity) associated with the change in relative position of the measurement optical system 20, and the height Z_{B} of the point B is determined on the basis of the optical path difference between the measurement light 24a₁ and the reference light 24a₂ obtained when the rate of change of the light intensity becomes greatest. This makes it possible to identify the pixel P satisfying the constructive interference condition, for such a reason that there is a difference in reflectance on the front surface 11a, and the like, even in a case in which it is difficult to determine whether or not the constructive interference condition is satisfied according to only the magnitude of the light intensity. In other words, the shape measurement system 42 having high robustness and noise immunity can be realized.

Here, description will be given referring back to FIG. 1. The controller 40 controls the moving mechanism 6, the laser beam applying unit 8, the measurement optical system 20, and the like. The controller 40 includes a computer including, for example, a processor 40a typified by a central processing unit (CPU) and a memory 40b.

The memory 40b has a main storage unit such as a dynamic random access memory (DRAM), an auxiliary storage unit such as a flash memory, a hard disk drive, or a solid-state drive. The auxiliary storage unit has software including a predetermined program stored therein. By operating the processor 40a and the like according to this software, the functions of the controller 40 are realized.

This software allows the camera 38 to image the front surface 11a of the workpiece 11 while changing the relative position between the measurement optical system 20 and the workpiece 11 along the X axis direction, thereby receiving the interference light at each of the relative positions by each of the plurality of photoelectric conversion elements 36a, and calculating the three-dimensional shape on the basis of information of each of the relative positions and an amount of light received by each of the photoelectric conversion elements 36a at each of the relative positions.

Note that the amount of light received by each of the photoelectric conversion elements 36a (that is, each of the pixels) corresponds to an amount of charge generated according to the intensity of the light received by the photodiode at the photoelectric conversion element 36a, and also corresponds to a voltage signal generated by the current/voltage conversion circuit at the photoelectric conversion element 36a.

As a matter of course, the controller 40 monitors in real time the relative position between the measurement optical system 20 and the workpiece 11 in the X axis direction and the Y axis direction, and this information regarding the relative position can be used by the software for calculation of the position information of the front surface 11a. After the front surface 11a is scanned in the X axis direction from one end to the other end of the front surface 11a with the measurement light 24a₁, the controller 40 causes the moving mechanism 6 to move the measurement optical system 20 and the workpiece 11 in the Y axis direction (that is, perform index feeding) by a predetermined amount (for example, a spot diameter of the measurement light 24a₁ on the front surface 11a). By repeating scanning the front surface 11a in the X axis direction with the measurement light 24a₁ and index feeding in the Y axis direction, substantially the entire region of the front surface 11a is scanned with the measurement light 24a₁. Note that not substantially the entire region of the front surface 11a, but only a region to be measured for the three-dimensional shape of the front surface 11a may be scanned with the measurement light 24a₁.

The software sequentially calculates the irregularities of the front surface 11a of the workpiece 11 on the basis of the above-described equation (1) or (2) according to the light intensity measured by the photoelectric conversion element 36a which receives the interference light between the measurement light 24a₁ reflected by the front surface 11a and the reference light 24a₂. Specifically, the software calculates the three-dimensional shape of the front surface 11a according to information regarding each of the relative positions between the measurement optical system 20 and the workpiece 11 and the amount of light received by the photoelectric conversion element 36a at each of the relative positions. The calculated three-dimensional shape of the front surface 11a is displayed on a display unit 44 by the controller 40. The display unit 44 is, for example, a touch panel display also serving as an input unit. An operator can perform setting on a processing condition and the like through the display unit 44.

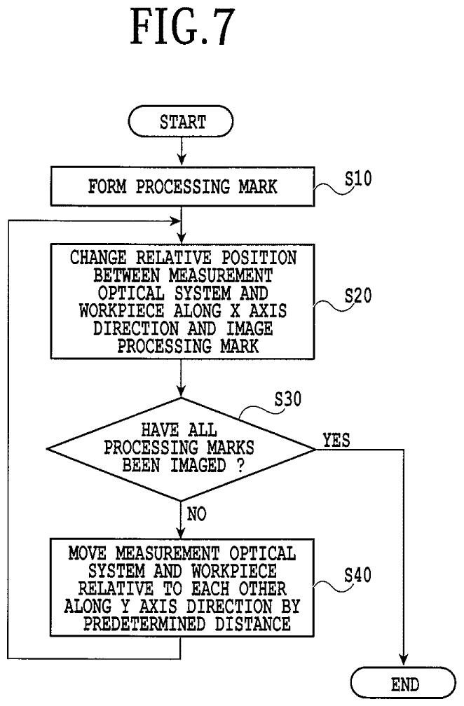

Next, with reference to FIG. 7 to FIG. 10B, description regarding a processing method in which the workpiece 11 is subjected to laser processing (that is, processing is performed on the workpiece 11) with use of the processing apparatus 2 will be given. Note that the processing method includes a shape measurement method of measuring the three-dimensional shape of the workpiece 11 (see S20, S30, and S40 in FIG. 7). FIG. 7 is a flowchart indicating the processing method of the workpiece 11. In the present embodiment, steps in S10 to S40 are performed in this order. First, the laser beam applying unit 8 performs ablation processing on the workpiece 11 (that is, processes the workpiece 11), and a processing mark 11d is formed in the workpiece 11 (see FIG. 9B) (processing step S10).

FIG. 8 is a perspective view of the workpiece 11 that has not undergone processing. The workpiece 11 includes a disc-like wafer formed of single-crystal silicon as a semiconductor material. The workpiece 11 has the circular front surface 11a and the circular back surface 11b. The front surface 11a has a plurality of dividing lines 13 set thereon, and the plurality of dividing lines 13 are perpendicular to each other. Each of a plurality of rectangular regions demarcated by the plurality of dividing lines 13 has a device 15 such as an integrated circuit (IC) provided therein. Each of the dividing lines 13 and each of the devices 15 are covered with a Low-k film (not depicted). However, the Low-k film is not essentially required. Moreover, there are no particular limitations on the material, the shape, the structure, the size, and the like of the wafer. The workpiece 11 may have a substrate formed of a semiconductor other than silicon (GaAs, SiC, GaN, or the like), diamond, sapphire, glass, ceramic, resin, metal, or the like. There are no particular limitations on the kind, the number, the shape, the structure, the size, the arrangement, and the like of the devices 15. The workpiece 11 may not have any device 15.

The annular frame 17 formed of metal is disposed at an outer peripheral portion of the workpiece 11 in such a manner as to surround the workpiece 11. The dicing tape 19 having a diameter larger than an opening of the frame 17 is attached to one surface of the frame 17 and the back surface 11b of the workpiece 11. That is, the workpiece 11 is supported through the dicing tape 19 by the frame 17. The workpiece 11, the frame 17, and the dicing tape 19 constitute the workpiece unit 21.

When the processing mark 11d is to be formed, the workpiece 11 is held under suction through the dicing tape 19 on the chuck table 4 such that the front surface 11a is exposed upward (see FIG. 9A). Note that, in FIG. 9A, as described above, illustration of the frame 17 and the dicing tape 19 is omitted. Then, after the position of the chuck table 4 is adjusted in such a manner that the focal point of the laser beam L is positioned near the front surface 11a in the Z axis direction and positioned on an extension line of one of the dividing lines 13 in the X axis direction, the chuck table 4 is moved along the X axis direction with the laser beam L being applied. The laser processing condition is set as follows, for example.
Wavelength: 355 nm
Average power: 0.7 W
Repetition frequency: 200 kHz
Pulse width: 9 ps
Processing feed speed: 600 mm/s

FIG. 9A is a diagram depicting the manner in which ablation processing is performed on the workpiece 11. After processing is performed on the workpiece 11 from one end to the other end of one of the dividing lines 13 in the X axis direction, the chuck table 4 is moved by a predetermined amount of index feeding along the Y axis direction. Then, ablation processing is similarly performed on another one of the dividing lines 13 which is adjacent to the processed dividing line 13 in the Y axis direction. In this manner, after all the dividing lines 13 along the X axis direction are subjected to ablation processing, the chuck table 4 is rotated by approximately 90 degrees on the θ table of the moving mechanism 6. Then, ablation processing is similarly performed on unprocessed dividing lines 13.

FIG. 9B is a cross-sectional view depicting the workpiece 11 including the processing marks 11d formed in the front surface 11a by ablation processing. Each of the processing marks 11d is a processing groove portion having a predetermined depth from the front surface 11a (that is, having such a depth that the workpiece 11 is not fully cut), and has a processing groove 11d₁ and molten deposits 11d₂ that are positioned at both edges of the processing groove 11d₁.

Note that, although the molten deposit 11d₂ depicted in FIG. 9B is clearly illustrated for convenience of explanation, it is not always uniformly formed along the longitudinal direction of the dividing line 13. When the processing mark 11d is viewed from above, there is present a region in which the molten deposit 11d₂ is partly formed. Moreover, formation of the processing marks 11d in all the dividing lines 13 is not required, and the processing mark 11d may be formed in at least one dividing line 13. In place of this, in order to check the processing performance, a circular-or an elliptical-shaped processing mark 11d may be formed in part of one dividing line 13 or part of a test piece. In the present embodiment, after the processing mark 11d is formed in at least one dividing line 13 (that is, after the processing step S10), the relative position between the measurement optical system 20 and the workpiece 11 are changed along the X axis direction, and the processing mark 11d is imaged (imaging step S20).

In the imaging step S20, as described above, applying the measurement light 24a₁ among split beams of the low-coherence light 24a to the workpiece 11 held on the holding surface 4a through the objective lens 30 and receiving the interference light resulting from interference between the reference light 24a₂ and the measurement light 24a₁ reflected on the front surface 11a of the workpiece 11 by the camera 38 (light receiving step), and changing the relative position between the camera 38 and the workpiece 11 along the X axis direction (X axis direction moving step) are performed.

For example, in the imaging step S20, first, one end portion of the processing mark 11d in the X axis direction is irradiated with the measurement light 24a₁ (see FIG. 10A). FIG. 10A is a diagram depicting the manner in which imaging of one processing mark 11d is started. While the chuck table 4 is moved to the +X-direction side at a predetermined speed (for example, 50 mm/s) in a state in which the one end portion of the processing mark 11d is irradiated with the measurement light 24a₁, substantially the entire region of the one processing mark 11d is imaged to the other end of the processing mark 11d in the X axis direction. FIG. 10B is a diagram depicting the manner in which imaging of the one processing mark 11d is ended.

Note that, in the present embodiment, substantially the entire region of the one processing mark 11d is imaged in a single scan in the X axis direction, but this is not limited, and substantially the entire region of the one processing mark 11d may be imaged in multiple scans in the X axis direction. For example, the spot diameter of the measurement light 24a₁ at the front surface 11a may be made narrower, and portions slightly shifted from the one processing mark 11d in the Y axis direction may sequentially be scanned, resulting in imaging of substantially the entire region of the one processing mark 11d. In addition, by changing the position of the focal point of the measurement light 24a₁ in the Z axis direction for each scan, substantially the entire region of the one processing mark 11d may be imaged.

As described above, the measurement optical system 20 moves the camera 38 and the objective lens 30 relative to the chuck table 4 along the X axis direction in a state in which the optical axis 30a of the objective lens 30 is inclined to the X axis direction at the predetermined angle φ, to scan the workpiece 11 with the measurement light 24a₁. Then, by receiving the interference light resulting from the interference between the measurement light 24a₁ reflected by the workpiece 11 and the reference light 24a₂ by the camera 38 (light receiving step), and changing the relative position between the camera 38 and the workpiece 11 in the X axis direction (X axis direction moving step), the three-dimensional shape of the workpiece 11 is measured.

In contrast, in the related technique, moving the measurement optical system 20 having the objective lens 30 with the optical axis 30a that is disposed parallel to the Z axis direction relative to the chuck table 4 in the Z axis direction and shifting the measurement optical system 20 relative to the chuck table 4 in the X axis direction by a predetermined distance are repeated, so that the height information regarding the workpiece 11 in a strip-like region along the X axis direction is acquired.

In the present embodiment, this repetitive operation can be significantly simplified, so that the measurement time for measuring the three-dimensional shape of the workpiece 11 can be more reduced than that of the related technique. After the imaging step S20, the controller 40 determines whether or not all the processing marks 11d formed in the workpiece 11 have been imaged (determining step S30). In a case in which not all the processing marks 11d have been imaged (NO in S30), the measurement optical system 20 and the workpiece 11 are moved relative to each other along the Y axis direction by a predetermined distance (index feeding step S40). Then, the flow is returned to the imaging step S20, and another processing mark 11d adjacent to the imaged processing mark 11d is similarly imaged. By repeating the imaging step S20 and the index feeding step S40, all the processing marks 11d are eventually imaged. In a case in which all the processing marks 11d have been imaged (YES in S30), the flow is ended.

### Second Embodiment

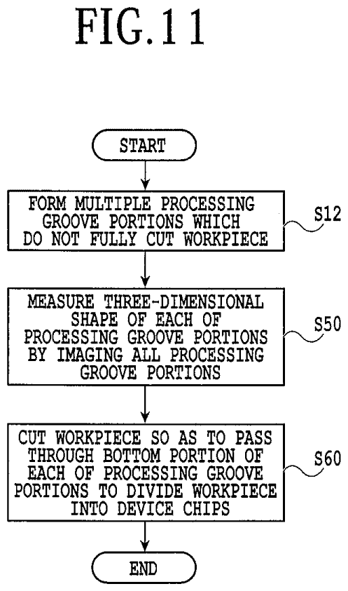

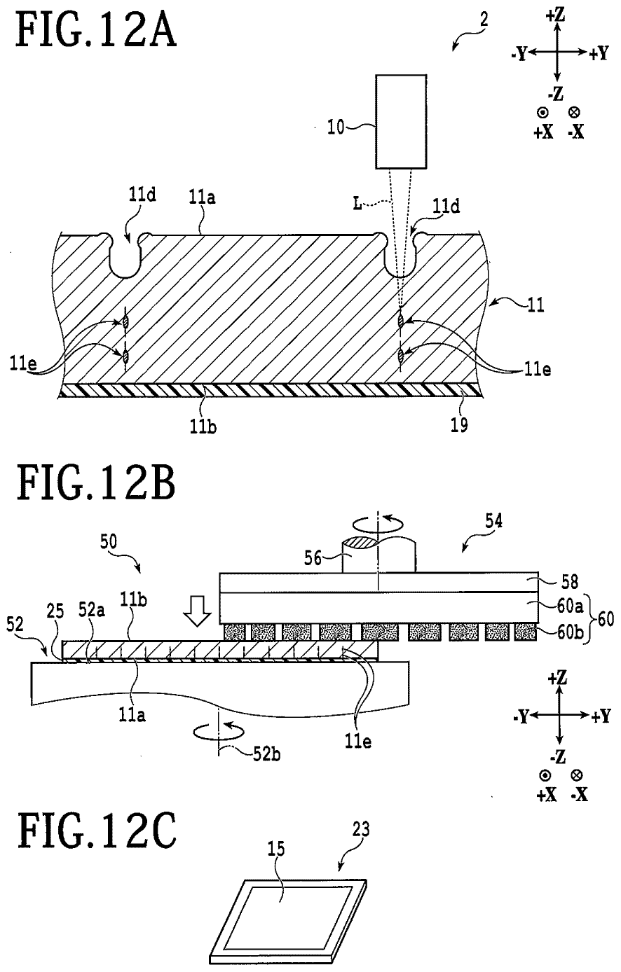

Next, with reference to FIG. 11 to FIG. 12C, a second embodiment will be described. The second embodiment relates to a device chip manufacturing method of manufacturing a plurality of device chips 23 (see FIG. 12C) from the workpiece 11.

FIG. 11 is a flowchart indicating one example of the device chip manufacturing method for the device chips 23. Also in the second embodiment, as in the processing step S10 of the first embodiment, ablation processing using the laser beam L forms the processing groove portion (that is, the processing mark 11d described above) in each of the dividing lines 13 (processing step S12). After the processing step S12, the imaging step S20, the determining step S30, and the index feeding step S40 in the first embodiment are appropriately repeated (shape measuring step S50). Through these processes, all the processing groove portions are imaged, and the three-dimensional shapes thereof are measured. As a matter of course, in the shape measuring step S50, in comparison with the vertical scanning low-coherence interferometry in the related technique, the measurement time for measuring the three-dimensional shape can be reduced.

After all the processing groove portions are imaged and the three-dimensional shape of each of the processing groove portions is measured, the process goes to a dividing step S60 of the workpiece 11. In the dividing step S60 of the present embodiment, first, a modified region 11e with a reduced mechanical strength is formed between a bottom portion 11d₃ of the processing groove 11d₁ and the back surface 11b of the workpiece 11 along each of the dividing lines 13 (a modified region forming step in the dividing step S60, see FIG. 12A). FIG. 12A is a diagram depicting the modified region forming step. In the modified region forming step, substantially the same processing apparatus 2 that is used for ablation processing can be used. Hence, in FIG. 12A, components having the same functions as those of the processing apparatus 2 are denoted as the same reference signs depicted in the processing apparatus 2 of FIG. 1. However, the laser beam applying unit 8 depicted in FIG. 12A causes the beam condenser 10 to emit a pulsed laser beam L having not a wavelength that is absorbed by the workpiece 11 but a wavelength that can be transmitted through the workpiece 11 (for example, 1064 nm).

In the modified region forming step, in a state in which the focal point of the laser beam L is positioned between the bottom portion 11d₃ of the processing groove 11d₁ and the back surface 11b of the workpiece 11 in the Z axis direction, the chuck table 4 is moved along the X axis direction. The laser processing condition is, for example, set as follows.
Wavelength: 1064 nm
Average power: 1.0 W
Repetition frequency: 30 kHz
Pulse width: 3 ns
Processing speed: 165 mm/s
Pass number: 2

In the modified region forming step, with use of the three-dimensional shape of the processing groove portion (that is, the processing mark 11d) obtained in the shape measuring step S50, the depth position of the focal point of the laser beam L in the Z axis direction can be adjusted. For example, due to a surface roughness at the bottom portion 11d₃ of the processing groove 11d₁, the position of the focal point may be varied for each of the dividing lines 13, but the position of the beam condenser 10 in the Z axis direction is finely adjusted, so that possible variation of the modified region 11e for each of the dividing lines 13 due to the surface roughness of the bottom portion 11d₃ can be reduced.

After the modified region 11e is formed along each of the dividing lines 13, the back surface 11b of the workpiece 11 is ground by a grinding apparatus 50 (the back surface grinding step in the dividing step S60, see FIG. 12B). The grinding apparatus 50 has a disc-shaped chuck table 52.

The chuck table 52 has a holding surface 52a that holds under suction the workpiece 11. The holding surface 52a has a conical shape having a center portion projecting slightly greater (for example, by 20 μm) than an outer peripheral portion, but since an amount of projecting is small, the holding surface 52a is depicted substantially flat in FIG. 12B. Below the chuck table 52, a rotational drive source (not depicted) such as a servomotor is provided. The chuck table 52 is rotatable around a rotational axis 52b positioned at a radially center portion of the chuck table 52. The rotational axis 52b is inclined such that part of the holding surface 52a is substantially parallel to the XY plane. However, since an inclination amount is small, the rotational axis 52b is depicted substantially parallel to the Z axis direction in FIG. 12B. Above the chuck table 52, there is a grinding unit 54.

The grinding unit 54 is configured to be movable along the Z axis direction by a Z axis direction moving mechanism (not depicted). The grinding unit 54 has a cylindrical spindle 56 disposed along the Z axis direction. The spindle 56 has a disc-shaped mount 58 fixed to a lower end portion thereof. The mount 58 has an annular grinding wheel 60 attached to a lower surface thereof. The grinding wheel 60 has an annular wheel base 60a. The wheel base 60a has a plurality of grinding stones 60b disposed on a lower surface thereof along a circumferential direction of the wheel base 60a at a substantially equal distance.

In the back surface grinding step using the grinding apparatus 50, first, the workpiece 11 is held under suction on the holding surface 52a. In the present example, the front surface 11a of the workpiece 11 is covered with a resin protective member 25, and the workpiece 11 is held under suction on the holding surface 52a in such a manner that the back surface 11b is exposed. Then, while the chuck table 52 and the spindle 56 are individually rotated at a predetermined speed, the grinding unit 54 is processing fed downward at a predetermined speed. A region of the back surface 11b that is substantially parallel to the XY plane is ground by being brought into contact with the plurality of grinding stones 60b.

Although the ground region of the back surface 11b is a half arc, the chuck table 52 is rotated around the rotational axis 52b, and accordingly, the entire region of the back surface 11b is uniformly ground, resulting in reduced thickness of the workpiece 11. In the back surface grinding step, the workpiece 11 is reduced in thickness, and with use of impact on the workpiece 11, cracks extend from the modified region 11e. The cracks reach the front surface 11a and the back surface 11b, so that the workpiece 11 is cut along the dividing lines 13 in such a manner as to pass through the bottom portion 11d₃ of the processing groove portion, thereby being divided into a plurality of device chips 23. FIG. 12B is a diagram depicting the back surface grinding step, and FIG. 12C is a perspective view of one of the plurality of device chips 23. In the present embodiment, by performing the modified region forming step and the back surface grinding step, the dividing step S60 is performed. However, after the three-dimensional shape of each of the processing groove portions is measured, in place of the modified region forming step and the grinding step, by blade dicing using a cutting apparatus (not depicted), the workpiece 11 may be cut along each of the dividing lines 13, to be divided into the plurality of device chips 23.

### Modification Example of Second Embodiment

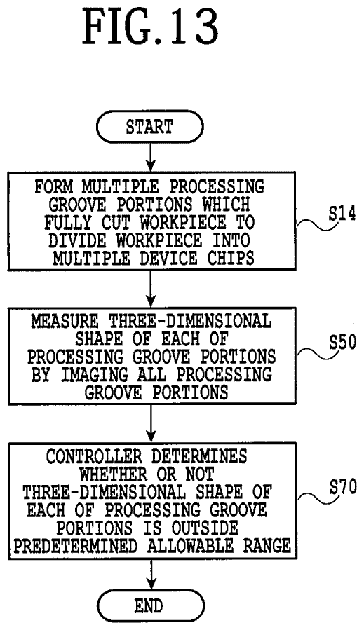

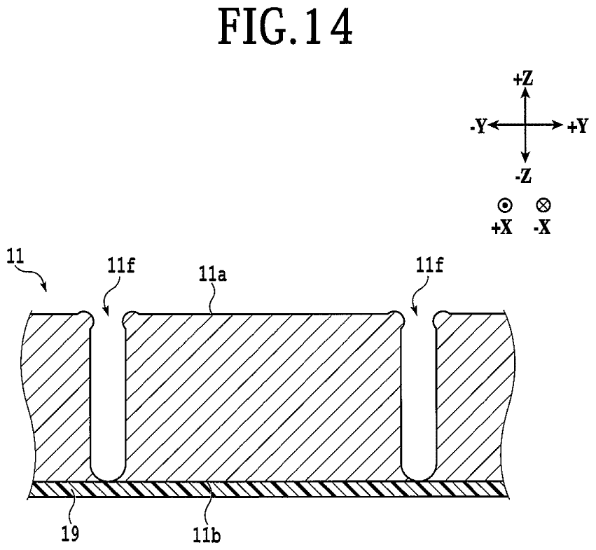

Next, with reference to FIG. 13 and FIG. 14, a modification example of the second embodiment will be described. FIG. 13 is a flowchart indicating a modification example of the manufacturing method for the device chip 23. In the modification example, unprocessed workpiece 11 is subjected to ablation processing, and formation of processing groove portions 11f for fully cutting the workpiece 11 along each of the dividing lines 13 allows the workpiece 11 to be divided into the plurality of device chips 23 (processing step S14). FIG. 14 is a cross-sectional view of the workpiece 11 having been subjected to cutting by ablation processing.

After the processing step S14, the shape measuring step S50 is performed (that is, the imaging step S20, the determining step S30, and the index feeding step S40 in the first embodiment are appropriately repeated). Accordingly, all the processing groove portions 11f are imaged, and the three-dimensional shape of each of the processing groove portions 11f is measured. After the three-dimensional shapes of all the processing groove portions 11f are measured, whether or not the three-dimensional shapes of the processing groove portions 11f obtained in the shape measuring step S50 are outside a predetermined allowable range is determined by the controller 40 (determining step S70). After the determining step S70, the flow is ended. Also in the modification example, in comparison to the vertical scanning low-coherence interferometry in the related technique, the measurement time for measuring the three-dimensional shape can be shortened.

In addition, in the modification example, in a case in which the three-dimensional shape of the processing groove portion 11f is outside the predetermined allowable range, it is determined by the controller 40 that the device chip 23 constituting the processing groove portion 11f that is outside the allowable range is a defective product. Through such an inspection for fine shapes of an object having undergone laser processing, for example, an operator may take an option for discarding the device chip 23 that has been determined to be a defective product. Hence, a possibility in which a defect occurs in a finished product equipped with the device chip 23 can be reduced.

Other than those described above, the structures, methods, and the like concerning the above-described embodiments can be modified as required in carrying out the present invention insofar as the modifications do not depart from the scope of the object of the invention. According to the embodiments and the modification examples described above, a case in which the three-dimensional shape of the processing mark 11d or the like formed by laser processing is measured by the measurement optical system 20 has been described, but the three-dimensional shape of a region processed by machine processing such as cutting, grinding, or polishing may be measured by the measurement optical system 20.

Moreover, for example, in place of the camera 38 described above, an event camera also called an event-based vision sensor (EVS) can be used. The event camera also has a solid-state imaging element, and an imaging surface of the solid-state imaging element has a plurality of photoelectric conversion elements provided thereon in a regular manner (for example, in a grid-like manner), each of the photoelectric conversion elements being capable of receiving the interference light. Each of the photoelectric conversion elements includes, for example, a photodiode and a current and voltage conversion circuit, to generate a voltage signal corresponding to the intensity of received light. The slid-state imaging element includes a light intensity change detecting circuit provided integrally with a region in which the plurality of photoelectric conversion elements are provided.

The light intensity change detecting circuit does not always output the voltage signals of all the photoelectric conversion elements to the controller 40. The light intensity change detecting circuit selectively outputs event data to the controller 40 according to the light intensity change at the photoelectric conversion element. The event data includes information for identifying (A) coordinates (x, y) (that is, the position) of the photoelectric conversion element having a light intensity change and (B) information (i) indicating that there is a positive or a negative light intensity change at the photoelectric conversion element, and moreover, includes (C) time (t) (that is, a time stamp) at which a light intensity change occurs. Note that, whether or not there is a light intensity change at the photoelectric conversion element is determined by the light intensity change detecting circuit, according to comparison between measured light intensity and a threshold, for example. However, the threshold is appropriately updated for each of the photoelectric conversion elements over time.

The event camera does not output the voltage signals from all the photoelectric conversion elements for each frame to the controller 40, but outputs the event data corresponding to only the photoelectric conversion element where a light intensity change occurs, to the controller 40. Hence, it is possible to reduce the amount of information at each frame more than a typical CMOS image sensor. By use of the event camera, compared to a case in which the interference light is received by the typical CMOS image sensor, the amount of information regarding an image to be output to the controller 40 can be significantly reduced, so that a higher frame rate can be set. Hence, the present embodiment has an advantage in that measurement of the three-dimensional shape can be performed much higher.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A shape measurement system of measuring a three-dimensional shape of an object, comprising:
a holding unit which holds the object;
a measurement optical system which is disposed apart from the holding unit in a first direction;
a moving unit which moves the measurement optical system and the holding unit relative to each other along a second direction crossing the first direction; and
a controller which controls the moving unit,
wherein the measurement optical system includes
a light source which emits low-coherence light,
a splitting section which splits the light from the light source into reference light which is applied to a reference surface serving as a reflecting surface and measurement light which is applied to the object,
an objective lens which focuses the measurement light onto the object, and
a photoelectric conversion device which has a plurality of photoelectric conversion elements which receive interference light resulting from interference between the reference light reflected by the reference surface and the measurement light reflected by the object, and
when the moving unit moves the measurement optical system and the holding unit relative to each other along the second direction to scan the object with the measurement light, an optical axis of the objective lens is inclined to the second direction at a predetermined angle.

2. The shape measurement system according to claim 1,
wherein the controller controls the moving unit to cause the photoelectric conversion device to image the object while changing a relative position between the measurement optical system and the object, thereby causing the plurality of photoelectric conversion elements to receive the interference light between the measurement light reflected by a measurement surface of the object and the reference light at each of relative positions, and calculating the three-dimensional shape of the object according to information regarding each of the relative positions and an amount of light received by each of the photoelectric conversion elements at each of the relative positions.

3. A processing apparatus which processes a workpiece, comprising:
a holding unit which holds the workpiece;
a processing unit which processes the workpiece;
a measurement optical system which is disposed apart from the holding unit in a first direction;
a moving unit which moves the measurement optical system and the holding unit relative to each other along a second direction crossing the first direction; and
a controller which controls the moving unit,
wherein the measurement optical system has
a light source which emits low-coherence light,
a splitting section which splits the light from the light source into reference light which is applied to a reference surface serving as a reflecting surface and measurement light which is applied to the workpiece,
an objective lens which focuses the measurement light onto the workpiece, and
a photoelectric conversion device which has a plurality of photoelectric conversion elements which receive interference light resulting from interference between the reference light reflected by the reference surface and the measurement light reflected by the workpiece, and
when the moving unit causes the measurement optical system and the holding unit to move relative to each other along the second direction to scan the workpiece with the measurement light, an optical axis of the objective lens is inclined to the second direction at a predetermined angle.

4. A shape measurement method of measuring a three-dimensional shape of an object, comprising:
applying, of low-coherence light which is split into reference light which is applied to a reference surface and measurement light which is applied to the object, the measurement light through an objective lens to the object held by a holding unit, and receiving interference light resulting from interference between the reference light reflected by the reference surface and the measurement light reflected by the object by a photoelectric conversion device; and
changing a relative position between the photoelectric conversion device and the object held by the holding unit which are disposed apart from each other in a first direction, along a second direction crossing the first direction,
wherein the three-dimensional shape of the object is measured by the receiving the interference light by the photoelectric conversion device and the changing the relative position between the photoelectric conversion device and the object in the second direction, and
in the changing the relative position between the photoelectric conversion device and the object along the second direction, in a state in which an optical axis of the objective lens is inclined to the second direction at a predetermined angle, the photoelectric conversion device and the objective lens are moved relative to the holding unit along the second direction to scan the object with the measurement light.

5. A processing method of processing a workpiece, comprising:
processing the workpiece by a processing unit to form a processing mark;
after formation of the processing mark, applying, of low-coherence light which is split into reference light which is applied to a reference surface and measurement light which is applied to the processing mark, the measurement light to the processing mark of the workpiece held by a holding unit through an objective lens, and receiving interference light resulting from interference between the reference light reflected by the reference surface and the measurement light reflected by the processing mark by a photoelectric conversion device; and
after formation of the processing mark, changing a relative position between the photoelectric conversion device and the processing mark of the workpiece held by the holding unit which are disposed apart from each other in a first direction, along a second direction crossing the first direction,
wherein a three-dimensional shape of the processing mark is measured by the receiving the interference light by the photoelectric conversion device and the changing the relative position between the photoelectric conversion device and the processing mark along the second direction, and
in the changing the relative position between the photoelectric conversion device and the processing mark along the second direction, in a state in which an optical axis of the objective lens is inclined to the second direction at a predetermined angle, the photoelectric conversion device and the objective lens are moved relative to the holding unit along the second direction to scan the processing mark with the measurement light.

6. A chip manufacturing method of manufacturing chips from a workpiece, comprising:
processing the workpiece by a processing unit to form a processing groove portion having such a depth as not to fully cut the workpiece;
after formation of the processing groove portion, measuring a three-dimensional shape of the processing groove portion; and
after measurement of the three-dimensional shape of the processing groove portion, cutting the workpiece so as to pass through a bottom portion of the processing groove portion, to divide the workpiece into chips,
wherein the measuring the three-dimensional shape of the processing groove portion includes
applying, of low-coherence light which is split into reference light which is applied to a reference surface and measurement light which is applied to the processing groove portion, the measurement light to the processing groove portion of the workpiece held by a holding unit through an objective lens, and receiving interference light resulting from interference between the reference light reflected by the reference surface and the measurement light reflected by the processing groove portion by a photoelectric conversion device, and
changing a relative position between the photoelectric conversion device and the processing groove portion of the workpiece held by the holding unit which are disposed apart from each other in a first direction, along a second direction crossing the first direction, and
in the changing the relative position between the photoelectric conversion device and the processing groove portion of the workpiece held by the holding unit along the second direction, in a state in which an optical axis of the objective lens is inclined to the second direction at a predetermined angle, the photoelectric conversion device and the objective lens are moved relative to the holding unit along the second direction to scan the processing groove portion with the measurement light.

7. A chip manufacturing method of manufacturing chips from a workpiece, comprising:
processing the workpiece by a processing unit and forming a processing groove portion which fully cuts the workpiece to divide the workpiece into chips; and
after formation of the processing groove portion, measuring a three-dimensional shape of the processing groove portion,
wherein the measuring the three-dimensional shape of the processing groove portion includes
applying, of low-coherence light which is split into reference light which is applied to a reference surface and measurement light which is applied to the processing groove portion, the measurement light to the processing groove portion of the workpiece held by a holding unit through an objective lens, and receiving interference light resulting from interference between the reference light reflected by the reference surface and the measurement light reflected by the processing groove portion by a photoelectric conversion device, and
changing a relative position between the photoelectric conversion device and the processing groove portion of the workpiece held by the holding unit which are disposed apart from each other in a first direction, along a second direction crossing the first direction, and
in the changing the relative position between the photoelectric conversion device and the processing groove portion of the workpiece held by the holding unit along the second direction, in a state in which an optical axis of the objective lens is inclined to the second direction at a predetermined angle, the photoelectric conversion device and the objective lens are moved relative to the holding unit along the second direction to scan the processing groove portion with the measurement light.
